(19) United States
(12) Patent Application Publication
(10) Pub. No.: US 2024/0378871 A1
(43) Pub. Date: Nov. 14, 2024

(54) METHODS AND SYSTEMS FOR FAULT TOLERANT TRAINING FOR REAL TIME DEFECT DETECTION IN MANUFACTURING

(71) Applicant: JIDOKA TECHNOLOGIES PRIVATE LIMITED, Chennai (IN)

(72) Inventors: Krishna Ananth IYENGAR, Chennai (IN); Mohan Nikam, Chennai (IN)

(73) Assignee: JIDOKA TECHNOLOGIES PRIVATE LIMITED, Chennai (IN)

(21) Appl. No.: 18/144,919

(22) Filed: May 9, 2023

(51) Int. Cl. G06V 10/778; G06T 7/00; G06V 10/764; G06V 10/774; G06V 10/776; G06V 10/82

(52) U.S. Cl. CPC G06V 10/7788; G06T 7/0004; G06V 10/764; G06V 10/774; G06V 10/776; G06V 10/82; G06T 2200/24; G06T 2207/20081; G06T 2207/20084; G06T 2207/20092; G06T 2207/30108

(57) ABSTRACT

Embodiments of the present disclosure discuss a system [100] and a method [200] for refining training images for object detection. Conventional systems provide inaccurate predictions of defects because of erroneous labeling of defects in training images. Further, existing systems focus on improving the algorithms used for object detection. Embodiments of the present disclosure address these problems by using supervised learning techniques and refining the training data provided to train the algorithms. The system [100] refines the training images using predictions of a first model and providing the predictions for human review, and subsequently uses the refined training images to create a second model that can be used in a production environment of an enterprise for object detection.

### FIELD OF INVENTION

The disclosure herein relates to a method and a system for fault tolerant training for real time defect detection in manufacturing.

### BACKGROUND

To train supervised learning algorithms in defect detection, humans visually inspect multiple images of components and label instances of defects in the images using bounding boxes. The supervised learning algorithms are trained using the multiple images with the labels to create machine learning models. The machine learning models consider all the regions of the images apart from the bounding boxes as defect free. Therefore, if the model makes any extra prediction of a defect within defect free region, the model is penalized through the loss function to avoid predicting such prediction the next time.

Human labeling of defects also results in erroneous labeling. In one example of an erroneously labeled image, one of the two defect instances is not labeled. When this erroneously labeled image is provided as a training image, the supervised learning algorithm learns that the unlabeled instance is not a defect. As a result, the model obtained after training mispredicts the defects in the images. Such instances of labeling error leads to model prediction error, which is very difficult to diagnose.

Hence there is a need for a system with a better training pipeline and an improved loss function which models the defect instances without resulting in mispredictions caused by unlabeled instances of defects. Furthermore, higher turnaround time from labeling to an accurate model is highly desirable.

### SUMMARY

Embodiments of the present disclosure present technological improvements as solutions to one or more of the above-mentioned technical problems.

For example, in one embodiment, a method for training in object detection is provided. The method comprises receiving, by a processor, from a client device, training images comprising positive images with defects and negative images with no defects; using, by the processor, the training images to train a supervised learning algorithm to create a first model for object detection; inputting, by the processor, the training images to the first model which predicts in the training images, one or more of the labeled defects and one or more additional defects, wherein the first model comprises a loss function which penalizes prediction of additional labeled defects in the negative images and does not penalize prediction of additional labeled defects in the positive images; outputting, by the processor, the training images with the predicted one or more of the labeled defects and the one or more additional defects to the client device for human review; receiving, by the processor, inputs on the one or more additional defects from the client device based on the human review; and using, by the processor, the training images with the predicted one or more of the labeled defects and with the inputs received on the one or more additional defects to train the supervised learning algorithm to create a second model for object detection.

In another embodiment, a system for training in object detection is described. The system comprises a memory and at least one processor communicatively coupled to the memory, wherein the processor is configured to execute instructions stored in the memory to: receive from a client device, training images comprising positive images with labeled defects and negative images with no labeled defects; use the training images to train a supervised learning algorithm to create a first model for object detection; input the training images to the first model which predicts in the training images, one or more of the labeled defects and one or more additional defects, wherein the first model comprises a loss function which penalizes prediction of additional labeled defects in the negative images and does not penalize prediction of additional labeled defects in the positive images; output the training images with the predicted one or more of the labeled defects and the one or more additional defects to the client device for human review; receive inputs on the one or more additional defects from the client device based on the human review; and use the training images with the predicted one or more of the labeled defects and with the inputs received on the one or more additional defects to train the supervised learning algorithm to create a second model for object detection.

### BRIEF DESCRIPTION OF THE DRAWINGS

FIG. 1 illustrates a block diagram of an exemplary environment with an example of a system for object detection.

FIG. 2 illustrates an exemplary flow diagram of a processor implemented method for refining training data provided to a supervised learning algorithm.

FIG. 3 is an example of refining training images according to one or more steps of the processor implemented method of FIG. 2.

FIG. 4A illustrates an example image of a component comprising one or more bounding boxes with defect labels.

FIG. 4B illustrates an example image of a component comprising one bounding box with a defect label.

### DETAILED DESCRIPTION OF EMBODIMENTS

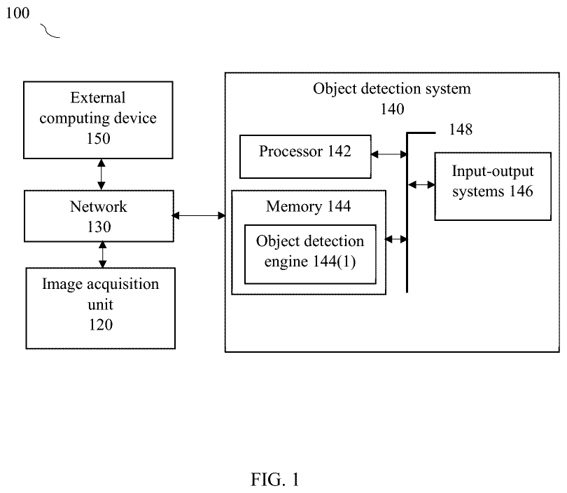

A block diagram of an exemplary environment 100 with an example of a system for object detection is illustrated in FIG. 1. The exemplary environment 100 includes an image acquisition unit 120, an object detection system 140, and an external computing device 150 coupled together by a network 130, although the environment 100 can include other types or numbers of devices, components, elements, and communication networks in other topologies and deployments.

The image acquisition unit 120 may include at least one camera to acquire the images of components (e.g. surfaces, components, articles, or the like) placed in the field of view of the at least one camera. The image acquisition unit 120 may be configured to capture various images of the components by rotating the components in different axes. In embodiments, the image acquisition unit 120 may include a camera unit for capturing the images and a light unit for illuminating the components under test. The image acquisition unit 120 may include software or hardware to process the captured images. The software or the instructions in the hardware may include artificial intelligence or machine learning algorithms providing intelligence to the image acquisition unit. Further, the image acquisition unit 120 may be capable of outputting the captured images, or processed images to external systems via the network 130.

The network 130 may include, or operate in conjunction with an adhoc network, an intranet, an extranet, internet, a virtual private network, a wired network such as a local area network (LAN), a wide area network (WAN), wireless networks such as wireless local area network (WLAN), Wi-Fi®, Bluetooth®, cellular networks such as 5G, LTE, 4G, 3G, or a combination of two or more such networks.

The object detection system 140 comprises a processor 142, a memory 144, input-output systems 146, and a communication bus 148. The processor 142 may include any number of processing units that read data from the memory 144. The processor 142 is configured to fetch and execute computer readable instructions stored in the memory. Specifically, the processor 142 is programmed to execute instructions to implement the embodiments of the disclosure. The processor 142 may also include an internal memory (not shown).

The memory 144 is used to store and provide access to instructions to implement the embodiments of the disclosure. The memory 144 specifically includes an object detection engine 144(1) comprising instructions to implement the embodiments of the disclosure. In embodiments, the memory 144 includes tangible, non-transitory computer readable medium known in the art including, for example, volatile memory such as static random access memory (SRAM), dynamic random access memory (DRAM), non-volatile memory such as read-only memory (ROM), erasable programmable ROM, flash memories, hard disks, optical disks, or magnetic tapes, removable memory, non-removable memory, or a combination thereof. The object detection engine 144(1) may include code or instructions corresponding to machine learning algorithms, deep learning algorithms, convolutional neural networks, business logic, image processing, or the like, which may be used to implement the embodiments of the disclosure. The memory 144 may also include routines, programs, data structures, or the like.

The input-output systems 146 may include input-output ports or other such hardware interfaces, systems, and their corresponding software, which enable the object detection system 140 to communicate with external devices. In one example, the object detection system 140 may use the input-output systems 146 to communicate with the image acquisition unit 120 or the external computing device 150 via the network 130. In one example, the input-output system 146 may include a network interface controller for Ethernet or a wireless adapter for Wi-Fi®.

The communication bus 148 directly or indirectly couples the processor 142, the memory 144, and the input-output systems 146. The communication bus 148 may include one or more buses (such as an address bus, data bus, a control bus, or a combination thereof). The communication bus 148 may be a Video Electronics Standards Association Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a combination thereof.

In embodiments, the object detection system 140 may be hardware such as an application specific integrated circuit (ASIC), a field programmable gate array (FPGA), a prototyping platform, a physical programmable circuit board, or the like. In other embodiments, the object detection system 140 may be available as a cloud-based service. The object detection system 140 may be offered as machine learning as a service (MLaaS). The object detection system 140 may be hosted in a public cloud, a private cloud, or a hybrid cloud. The features of the object detection system 140 may also be accessed by external computing devices 150 using application programming interfaces (APIs).

The external computing device 150 may include a laptop, a desktop, a smartphone, a tablet, a wearable, or the like. There may be one or more such external computing devices 150 directly or communicatively coupled to the object detection system 140 via the network 130. The external computing device 150 may include application programs such as a browser. The browser includes program modules and instructions enabling the external computing device 150 to communicate with the object detection system 140 using, by way of example, Hypertext transfer protocol (HTTP) messaging via the network 130. In one example, the external computing device 150 may communicate with the object detection system 140 using APIs. The external computing device 150 may also communicate with the object detection system 140 using other network protocols known in the art. The external computing device 150 may also include object detection software which communicates with the object detection system 140.

In embodiments, the object detection system 140 may be a part of the external computing device 150. The object detection engine 144(1) may be installed as a software in the external computing device 150. The object detection engine 144(1) may also be installed as a hardware in the external computing device 150. In this example, the image acquisition unit 120 may provide the images of the components to the external computing device 150 which uses the object detection system 140, and more specifically the object detection engine 144(1) to determine if the component includes one or more objects (e.g. defects, parts, or the like). In the examples described herein, the object is a defect, although there may be other types and/or numbers of objects in other configurations.

In embodiments, the object detection system 140 may output instructions which may be used by the external computing device 150 to at least partially render a graphical user interface of an object detection software installed in the external computing device 150. In another example, the object detection software may be rendered in the browser of the external computing device 150. The images of the components may be provided to the external computing device 150. A human reviewer accessing the external computing device 150 labels one or more defects in the images using bounding boxes. In one example, the human reviewer also labels the images with a type of defect such as a dent, a crack, a scratch, or the like. The human reviewer may interact with the graphical user interface of the object detection software.

An administrator or developer accessing another graphical user interface provided by the object detection engine 144(1) may train a supervised learning algorithm hosted in the object detection engine 144(1) with the labeled images to create a model. The developer may train a supervised learning algorithm using the labeled images-machine learning, deep learning, or artificial intelligence algorithms of the object detection engine 144(1). The developers may also train convolutional neural networks (CNN), neural network based memories or other types of neural networks of the object detection engine 144(1). The graphical user interface also enables providing input images to the object detection engine 144(1) and receiving predictions of defects in the input images from the object detection engine 144(1).

In embodiments, the object detection system 140 may be part of a computing device such as a desktop, a laptop, a smartphone, or the like. In this embodiment, a user may use a programming console or a graphical user interface of the computing device to train the supervised learning algorithm hosted in the object detection system 140. The computing device may communicate with the image acquisition unit 120 via the network 130.

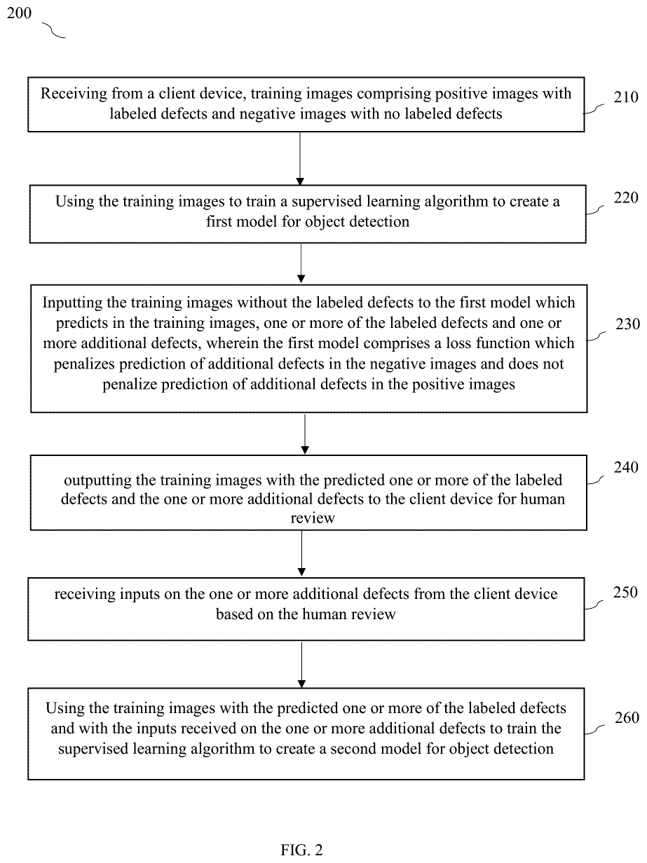

FIG. 2 illustrates an exemplary flow diagram of a processor implemented method for refining training data and creating a model using the refined training data. The method 200 may be implemented by the object detection system 140 of FIG. 1.

The embodiments disclosed herein discuss refinement of the training data used to create a model for object detection. The image acquisition unit 120 captures images of the components and sends the captured images to the object detection system 140 via the network 130. A human reviewer at the external computing device 150 accesses the captured images using a graphical user interface provided by the object detection system 140. The human reviewer may review the images and label one or more of the images with one or more defects and label one or more of the images as defect free. The human reviewer may label a defect in the images by outlining, using a bounding box, the one or more defects in the images. The bounding box provides coordinates of the defect in the images to the external computing device 150 or the object detection system 140. The human reviewer may also label the one or more images with one or more labeled defects as positive images and the one or more images with no labeled defects as negative images. In one example, the object detection system 140 may automatically label the images with one or more labeled defects as positive images and the one or more images with no labeled defects as negative images.

At step 210, the processor 142 receives from a client device, such as the external computing device 150, training images comprising positive images with labeled defects and negative images with no labeled defects. Each of the positive images comprise one or more labeled defects indicating a position of the defects.

At step 220, the processor 142 uses the training images to train a supervised learning algorithm to create a first model for object detection. In one example, the first model is a convolutional neural network. From the training images, the processor 142 extracts feature values from the one or more labeled defects of the positive images. The processor 142 also extracts features values which are indicative of defect free regions of the negative images. The processor 142 uses the extracted feature values from the first positive images and the negative images to create the first model.

At step 230, the processor 142 inputs the training images without the labeled defects to the first model which predicts in the training images, one or more of the labeled defects and one or more additional defects, wherein the first model comprises a loss function which penalizes prediction of additional defects in the negative images and does not penalize prediction of additional defects in the positive images. The loss function is a mathematical function which estimates the extent to which the first model models the training data. In one example, the training images used to create the first model comprise 70 positive images and 930 negative images. These training images without the labeled defects are provided to the first model as input and the first model predicts 75 positive images and 925 negative images. In this example, the first model predicts defects in 5 of the 930 negative images. The loss function of the first model penalizes the prediction of the additional defects in these five negative images. In another example, the training images used to create the first model comprise 70 positive images and 930 negative images. These training images without the labeled defects are provided to the first model as input and the first model predicts 70 positive images and 900 negative images. However, the first model predicts additional defects, which were not provided as training to the supervised learning algorithm, in 5 of the 70 positive images. The loss function of the first model does not penalize the prediction of additional defects in the positive images.

At step 240, the processor 142 outputs the training images with the predicted one or more of the labeled defects and the one or more additional defects to the client device, such as the external computing device 150, for human review. In one example, the first model is a classifier which predicts in the training images the one or more of the labeled defects and the one or more additional defects. The human reviewer may provide inputs on the one or more additional defects. In one example, the human reviewer may accept, reject, or modify the one or more additional defects. The processor 142 may provide indicators to the external computing device 150 to view the one or more additional defects and subsequently the human reviewer may accept, reject, or modify the one or more additional defects. In one example, the modification may include the human reviewer changing a label of the one or more additional defects. In another example, the modification may include the human reviewer enlarging or diminishing the bounding box of the defect predicted by the first model.

In one embodiment, the object detection system 140 may initiate a workflow for human review only when there is a difference in defects between the training images used to train the first model and the predictions of the first model. In one example, the difference exists when the first model predicts additional defects other than the labeled defects used to train the first model. In another example, the difference exists when the first model predicts a different label than the one provided by the human reviewer as training to create the first model. If the object detection system 140 does not determine any differences between the defect labels used to train the first model and the predictions of the first model, the object detection system 140 provides an output such as a notification to the external computing device 150 to use the first model for object detection.

At step 250, the processor 142 receives inputs on the one or more additional defects from the client device based on the human review. In one example, the received inputs based on the human review comprises the acceptance, rejection, or modification of the one or more additional defects.

At step 260, the processor 142 uses the training images with the predicted one or more of the labeled defects and with the inputs received on the one or more additional defects to train the supervised learning algorithm to create a second model for object detection. The second model may be deployed in a production environment of an enterpise for object detection.

The disclosed method 200 improves when deployed for object detection improves the accuracy of object detection, reduces the effort of human reviewers, and amends the issues caused by erroneous labeling of defects.

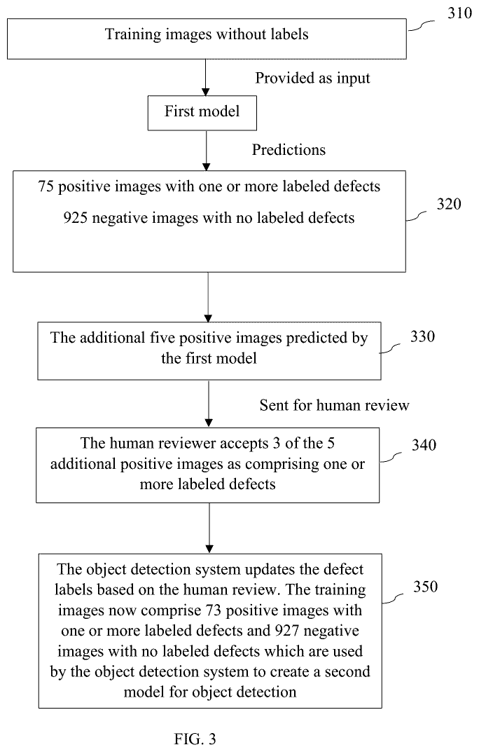

FIG. 3 is an example of refining training images according to one or more steps of the processor implemented method 200. The training data provided to create the first model comprises human labeled images. In this example, the human labeled images used to create the first model comprise 70 positive images with one or more labeled defects and 930 negative images with no labeled defects. After the first model is created, at step 310, the training images without the labels are provided to the first model. At step 320, the first model predicts 75 positive images with one or more labeled defects and 925 negative images with no labeled defects. The first model predicted an additional five positive images with one or more labeled defects. At step 330, the additional five positive images are sent to the external computing device 150 for human review. In one example, the object detection system 140 may send the 75 positive images with one or more labeled defects with indicators highlighting the additional five positive images predicted by the first model.

The human reviewer may inspect the additional five positive images with one or more labeled defects and determine that only three of the additional five positive images comprise one or more defects. At step 340, The human reviewer may accept the three of the additional five positive images and reject two of the additional five positive images. The acceptance or rejection provided by the human reviewer are transmitted to the object detection system 140. At step 350, the object detection system 140 updates the defect labels based on the human review. The training images now comprise 73 positive images with one or more labeled defects and 927 negative images with no labeled defects which are used by the object detection system 140 to train a supervised learning algorithm to create a second model for object detection. In this manner, the quality of the training data provided to the supervised learning algorithm is improved thereby resulting in better models for object detection.

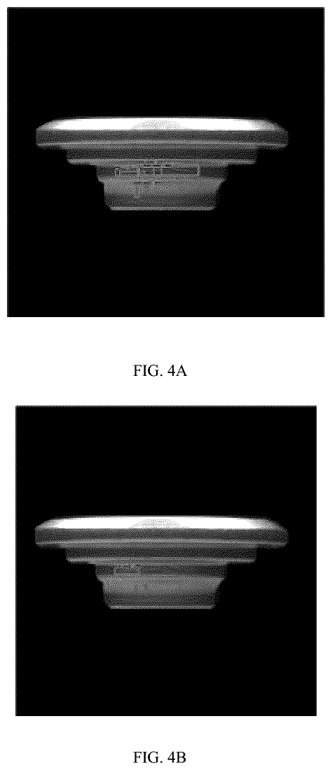

FIGS. 4A and 4B illustrate example images of a component comprising one or more bounding boxes with defect labels. These bounding boxes with defect labels may be added by a human reviewer or the first model. In one example, FIG. 4A comprises multiple bounding boxes with defect labels. The human reviewer may review these multiple bounding boxes and accept, reject, or modify and accept the defects. The human reviewer may reject all the bounding boxes in FIG. 4A and accept a single bounding as illustrated in FIG. 4B.

Having described the aspects of the embodiments in detail, it will be apparent that modifications are possible without departing from the scope of the embodiments as defined in the appended claims. It should also be understood that there is no intention to limit the disclosure to the specific embodiments disclosed, but on the contrary, the intention is to cover modifications, alternative constructions, and equivalents falling within the spirit and scope of the disclosure.

What is claimed is:

1. A method for training in object detection comprising:
receiving, by a processor (142), from a client device, training images comprising positive images with defects and negative images with no defects;
using, by the processor (142), the training images to train a supervised learning algorithm to create a first model for object detection;
inputting, by the processor (142), the training images without the labeled defects to the first model which predicts in the training images, one or more of the labeled defects and one or more additional defects, wherein the first model comprises a loss function which penalizes prediction of additional labeled defects in the negative images and does not penalize prediction of additional labeled defects in the positive images;
outputting, by the processor (142), the training images with the predicted one or more of the labeled defects and the one or more additional defects to the client device for human review;
receiving, by the processor (142), inputs on the one or more additional defects from the client device based on the human review; and
using, by the processor (142), the training images with the predicted one or more of the labeled defects and with the inputs received on the one or more additional defects to train the supervised learning algorithm to create a second model for object detection.

2. The method as claimed in claim 1, wherein the defects in the positive images are labeled as bounding boxes by a human reviewer at the client device.

3. The method as claimed in claim 1, wherein indicators to accept, reject, or modify the one or more additional defects are output to the client device.

4. The method as claimed in claim 3, wherein the received inputs comprise one or more actions of accepting, rejecting, or modifying the one or more additional defects from the client device.

5. The method as claimed in claim 1, wherein the first model is a classifier which predicts in the training images, one or more of the labeled defects and one or more additional defects.

6. The method as claimed in claim 1, wherein the first model is a convolutional neural network.

7. A system for refining training data for object detection comprising:
a memory (144); and
at least one processor (142) communicatively coupled to the memory (144), wherein the at least one processor (142) is configured to execute instructions stored in the memory to:
receive from a client device, training images comprising positive images with labeled defects and negative images with no labeled defects;
use the training images to train a supervised learning algorithm to create a first model for object detection;
input the training images without the labeled defects to the first model which predicts in the training images, one or more of the labeled defects and one or more additional defects, wherein the first model comprises a loss function which penalizes prediction of additional labeled defects in the negative images and does not penalize prediction of additional labeled defects in the positive images;
output the training images with the predicted one or more of the labeled defects and the one or more additional defects to the client device for human review; receive inputs on the one or more additional defects from the client device based on the human review; and
use the training images with the predicted one or more of the labeled defects and with the inputs received on the one or more additional defects to train the supervised learning algorithm to create a second model for object detection.

8. The system as claimed in claim 1, wherein the defects in the positive images are labeled as bounding boxes by a human reviewer at the client device.

9. The system as claimed in claim 1, wherein indicators to accept, reject, or modify the one or more additional defects are output to the client device.

10. The system as claimed in claim 9, wherein the received inputs comprise one or more actions of accepting, rejecting, or modifying the one or more additional defects from the client device.

11. The system as claimed in claim 1, wherein the first model is a classifier which predicts in the training images, one or more of the labeled defects and one or more additional defects.

12. The system as claimed in claim 1, wherein the first model is a convolutional neural network.
